(19) United States
(12) Patent Application Publication
(10) Pub. No.: US 2025/0322469 A1
(43) Pub. Date: Oct. 16, 2025

(54) INTELLIGENT LEGAL DOCUMENT GENERATION

(71) Applicant: LexText Inc., Newark, DE (US)

(72) Inventors: Peter HARRINGTON, Sunnyvale, CA (US); Jobe DANGANAN, San Francisco, CA (US)

(73) Assignee: LexText Inc., Newark, DE (US)

(21) Appl. No.: 19/175,368

(22) Filed: Apr. 10, 2025

Related U.S. Application Data
(60) Provisional application No. 63/632,449, filed on Apr. 10, 2024.

(51) Int. Cl. G06Q 50/18; G06F 16/3329; G06Q 10/10

(52) U.S. Cl. CPC G06Q 50/18; G06F 16/33295; G06Q 10/10

(57) ABSTRACT

Systems and methods are provided for automatic legal document generation. Input is received from a user, such as information on a type of document that the user intends to generate. The user is then prompted to enter a information to draft the document. Based on the interpretation of the user inputs, a generative AI document is produced. Quality checks are applied to the generative AI document product to ensure that any cases or references are properly cited and free of mistakes.

### CROSS REFERENCE TO RELATED APPLICATIONS

Pursuant to 35 U.S.C. § 119 (e), this application is entitled to and claims the benefit of the filing date of U.S. Provisional App. No. 63/632,449 filed Apr. 10, 2024, entitled “SYSTEM AND METHOD FOR AUTOMATIC DOCUMENT GENERATION”, the content of which is incorporated herein by reference in its entirety for all purposes.

### TECHNICAL FIELD

The present disclosure relates generally to document generation, and more specifically to mechanisms for intelligent, verified legal document generation.

### DESCRIPTION OF RELATED ART

In today's technology forward world, people rely more and more on generative artificial intelligence (AI) to help them accomplish various tasks, such as provide answers to questions, or even write stories given a prompt. In addition, people even supplement their work with generative AI products. However, generative AI is not yet advanced enough to extend to all areas of work. One area where generative AI is lacking is law. Lawyers spend a lot of time drafting legal documents. However, the basic facts or raw information is roughly 1/20th of the words contained in the documents. Because the words in a legal document are significant in nature in terms of importance or weight, a document that is fraught with errors or untrue facts can have very real legal consequences. Currently, the state of the art does not allow for a generative AI product that is accurate enough to use as a legal document. It would be very beneficial to have a system that automatically generates documents, such as legal documents, by only inputting the necessary specific information pertaining to a case. Thus, there is a need for an improved system and method for intelligent legal document generation.

### Overview

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One aspect of the present disclosure relates to a method. The method comprises receiving a user query for generating a document. Next, the method includes determining the type of document necessary to satisfy the query. Then a user interface configured to prompt necessary information is presented to the user. Next, necessary information input is received from the user. Then, the method includes generating, for presentation to an artificial intelligence (AI) model, one or more generative AI queries based on the received necessary information input. Then, the one or more generative AI queries is presented to the AI model. Next, a preliminary document result is received from the AI model. Then, the method includes checking for and correcting any hallucinations in the preliminary document result thereby creating a finalized document result. Last, the method includes presenting for display on the user interface the finalized document result.

In some embodiments, the artificial intelligence (AI) model is a language model or a large language model (LLM). In some embodiments, the document is legal pleading document. In some embodiments, the user interface is configured to display user prompts in a first window juxtaposed side-by-side to a second window. In some embodiments, the second window is configured to show real-time progress of the finalized document. In some embodiments, the hallucinations included fictitious or inaccurate cited cases as well as fictitious or inaccurate law. In some embodiments, the necessary information is extracted from an uploaded document from the user.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments.

FIG. 1 shows an example of a mechanism for intelligent legal document generation, in accordance with embodiments of the present disclosure.

FIG. 2 illustrates a flow chart of a technique for intelligent legal document generation, in accordance with embodiments of the present disclosure.

FIG. 3 illustrates one example of a mechanism for citation verification and hallucination prevention, in accordance with embodiments of the present disclosure.

FIG. 4 illustrates a screenshot of an example user interface, in accordance with embodiments of the present disclosure.

FIG. 5 illustrates one example of a complaint analyzer, in accordance with embodiments of the present disclosure.

FIG. 6 illustrates an example of a computer system, configured in accordance with one or more embodiments of the present disclosure.

### DESCRIPTION OF EXAMPLE EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, portions of the techniques of the present disclosure will be described in the context of generative AI. However, it should be noted that the techniques of the present disclosure apply to a wide variety of different computer systems. In the following description, numerous specific details are set forth in order to provide a thorough understanding of the present disclosure. Particular example embodiments of the present disclosure may be implemented without some or all of these specific details. In other instances, well-known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of connections, such as a bus, may reside between the processor and memory. Consequently, a connection does not necessarily mean a direct, unimpeded connection unless otherwise noted.

As mentioned above, there is a need for a way to generate a document as a generative AI product that is accurate enough for contexts that afford very little room for mistakes. The techniques and mechanisms of the present disclosure provide for a system and method for automatically generating such a document. An example embodiment is presented herein in the context of a legal document. According to various embodiments, the user selects the type of legal document that the user wishes to draft. In some embodiments, a particular type of pleading selected will determine the topology of the document, which can also be thought of as a template. The template then needs to be filled in. In some embodiments, necessary data is stored in an associative array, which may be persisted in longer term storage. Next, the user is taken through a workflow asking the user to provide necessary information to draft a pleading. The information may also come from one or more uploaded documents. In the case where documents are uploaded, relevant information is extracted from the documents. This relevant information is stored in an associative array which once again may be persisted. The information extracted from uploaded documents includes but is not limited to: plaintiff, plaintiff's home or place of business, defendant, defendant's home or place of business, selected court, allegations, venue, jurisdiction.

This extracted information is used either directly in drafting the document, as an input to an LLM, or to solicit user input. Portions of legal pleadings are generated by a single call to an LLM. The call to the LLM will consist of a prompt, and some combination of extracted information and user input. The LLM will output a portion of the final draft. This portion is saved to an associative array. These partially drafted portions are then pulled from the associative array and assembled into a full pleading.

After the complete document is drafted, it is run through a number of checks for quality, and consistency with whichever particular jurisdiction of the law that governs. One possible check is to see if the cited law (if any) is fictitious. A second check tests to see if the cited law is valid and applicable as it is used. Another check tries to assess weaknesses in the document that could lead it to being dismissed, for example, and suggests improvements.

In particular embodiments, if the user wishes to change any part of the document based on the checks, the system sends these portions to the LLM to be drafted. The LLM prompt will detail that the section needs to be rewritten and what is wrong with it. The LLM will then draft a new section which will be added to the associative array for final drafting. In some embodiments, a single LLM call is used to generate pleadings. In some embodiments, a specialized LLM is fine-tuned to generate pleadings.

The techniques and mechanisms of the present disclosure provide several benefits over the current art including efficiency, accuracy, accessibility, cost reduction, and innovation.

According to various embodiments, the techniques and mechanisms of the present disclosure automates the drafting of complex legal documents, potentially reducing drafting time by up to 90%. This allows legal professionals to reallocate valuable time towards client engagement and case strategy.

The techniques and mechanisms of the present disclosure incorporate advanced NLP and machine learning algorithms to ensure the accuracy and consistency of generated documents. Built-in quality checks further minimize errors, enhancing the reliability of legal documentation.

The techniques and mechanisms of the present disclosure makes legal services more accessible to a wider range of practitioners, especially benefiting solo practitioners and small firms with limited resources. This democratization of legal tools helps to level the playing field within the industry.

The techniques and mechanisms of the present disclosure streamlines document drafting processes, leading to reduced legal costs for clients. Efficiency gains enable more competitive pricing and the possibility of alternative billing models.

The techniques and mechanisms of the present disclosure integrate cutting-edge technologies to foster innovation in legal practices. The system's adaptability and learning capabilities ensure it remains effective over time, encouraging the ongoing adoption of technological solutions in the legal sector.

According to various embodiments, the system incorporates a complaint analyzer that automatically extracts structured information from filed complaints. This analyzer uses advanced natural language processing techniques to identify parties, causes of action, factual allegations, jurisdictional bases, and relief sought. The complaint analyzer further maps extracted factual allegations to specific elements of each cause of action, highlighting potential weaknesses where factual support may be insufficient. This element-by-element analysis provides attorneys with clear visualizations of complaint structure and enables more efficient identification of potential grounds for dismissal or areas requiring additional factual development during discovery.

To further enhance document accuracy and reduce hallucinations, the system implements Retrieval-Augmented Generation (RAG) technology that grounds AI-generated content in verified legal authorities. The RAG component pre-fetches relevant statutory provisions, case law, procedural rules, and jurisdiction-specific requirements before document generation begins. This approach creates a comprehensive legal context buffer that provides the AI models with authoritative sources directly applicable to the specific document being created. By anchoring generation in retrieved legal authorities rather than relying solely on the model's parametric knowledge, the system dramatically reduces the risk of fabricated citations or mischaracterized legal principles. The RAG implementation further incorporates temporal awareness, ensuring that only current legal authorities are applied and that superseded statutes or overruled precedents are appropriately flagged during the verification process.

According to various embodiments, the system may also integrate legal research capabilities that operate both independently and in conjunction with document generation workflows. The legal research component implements specialized search algorithms optimized for legal materials, including semantic matching for legal concepts, citation network analysis, and jurisdiction-specific relevance ranking. When initiated from within the document generation process, research queries are automatically contextualized based on the specific document section being drafted, the applicable jurisdiction, and the factual context provided by the user. In particular embodiments, the research system maintains bidirectional links between generated document sections and the underlying legal authorities, allowing dynamic updates if more recent or relevant precedent is subsequently identified.

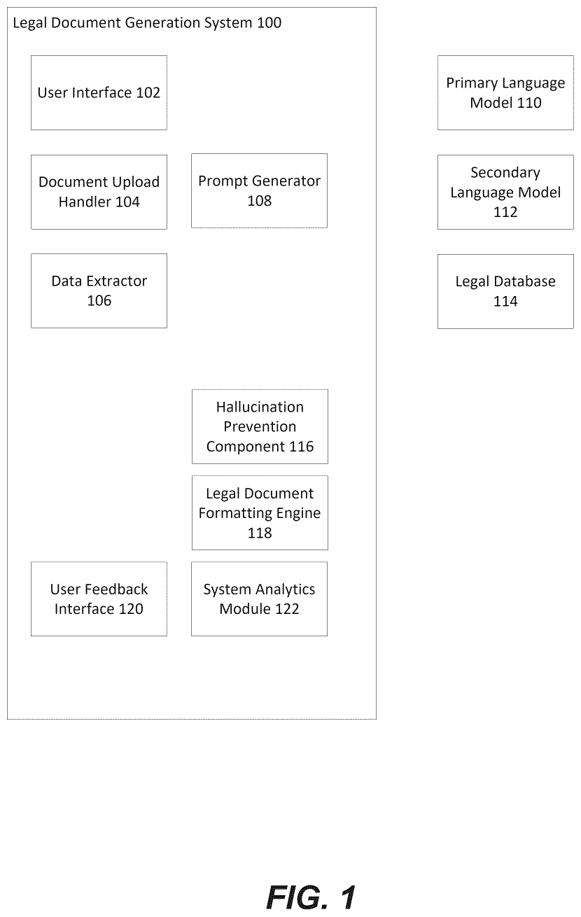

FIG. 1 illustrates an example system for automatic legal document generation, in accordance with embodiments of the present disclosure. The legal document generation system 100 may include multiple integrated components working together to produce accurate and properly formatted legal documents. In particular embodiments, legal documents include litigation documents such as pleadings, discovery documents, motions and briefs, court filings and procedural documents, as well as appellate filings.

According to various embodiments, pleadings include initiating and responsive filings such as complaints and answers. Additional pleadings include counterclaims, crossclaims, and third-party complaints, as well as amended pleadings, which modify previously filed complaints, answers, or motions. Discovery documents facilitate the exchange of information between parties and include requests for production (RFPs), requests for admissions (RFAs), and interrogatories (ROGs), as well as deposition notices, subpoenas, and discovery objections. Motions and briefs encompass motions to dismiss (MTDs), motions for summary judgment (MSJs), and oppositions to various motions, such as those seeking to compel discovery. Additional motions include protective orders, sanctions, reconsiderations, class certifications, injunctions, and venue transfers. Courts also require procedural filings, such as status reports, pre-trial statements, proposed orders, jury instructions, and case management statements, to ensure orderly case progression. In appellate proceedings, legal documents may include notices of appeal, appellate briefs (opening, answering, and reply briefs), writs of certiorari, amicus briefs, and petitions for review.

According to various embodiments, a user interface component provides an interface 102 for attorneys to input information associated with legal documents, offering structured fields for plaintiff and defendant details, jurisdiction selection, factual allegations, and document upload options. In particular embodiments, a document upload handler 104 processes incoming files, supporting various formats including PDFs, Word documents, and text files. According to various embodiments, a data extractor component 106 employs optical character recognition and natural language processing to identify and extract relevant information from uploaded documents, including party names, dates, legal precedents, and factual statements.

In particular embodiments, a prompt generator 108 takes user inputs and extracted data and reformulates them into optimized prompts for particular sections of a legal document for the language models by breaking complex document creation tasks into manageable segments such as jurisdictional statements, factual allegations, and legal arguments. The primary language model 110 or primary artificial intelligence (AI) model generates the initial draft content, leveraging its training on legal language and precedent to produce appropriate text for the specified document type. The primary language model 110 may be a primary AI model or large language model (LLM). According to various embodiments, a secondary language model 112 functions as a verification mechanism, receiving the same prompts without seeing the primary model's output to provide hallucination checking. The legal database connector 114 interfaces with authoritative sources that specialize in providing case law, state and federal statutes, administrative codes, and law review articles. Legal databases may include sources like LexisNexis or Westlaw, either through local installations or API connections, retrieving accurate case information, statutory references, and jurisdictional requirements that can be used for further verification using a hallucination prevention component 116 that implements a multi-layered verification process, comparing outputs from both language models against authoritative legal databases. The hallucination prevention component 116 can flag discrepancies and calculate confidence scores to identify potential fabrications or misinterpretations of legal precedents. The confidence score corresponds with a likelihood that a legal citation is not a hallucination.

According to various embodiments, a legal citation is a reference to authoritative sources that provides precise identification and location information for legal materials. Legal citations can include judicial decisions, statutory citations, regulatory citations, administrative code citations, administrative rules and procedures. In particular embodiments, legal document generation systems employ verification mechanisms that authenticate citations across all categories by querying authoritative databases to confirm the existence, currency, and substantive content of each referenced authority, thereby decreasing the risk of generating fabricated or mischaracterized legal sources that could undermine document validity.

According to various embodiments, a legal document formatting engine 118 provides that all generated content adheres to jurisdiction-specific requirements, applying appropriate styles, numbering systems, citation formats, and structural elements based on court rules. The user feedback interface 120 presents suggested improvements, identified issues, and alternative phrasings, allowing attorneys to review and approve changes before finalizing documents. The system analytics module 122 tracks document generation metrics, hallucination detection rates, and user acceptance patterns to continuously improve prompt engineering and verification processes.

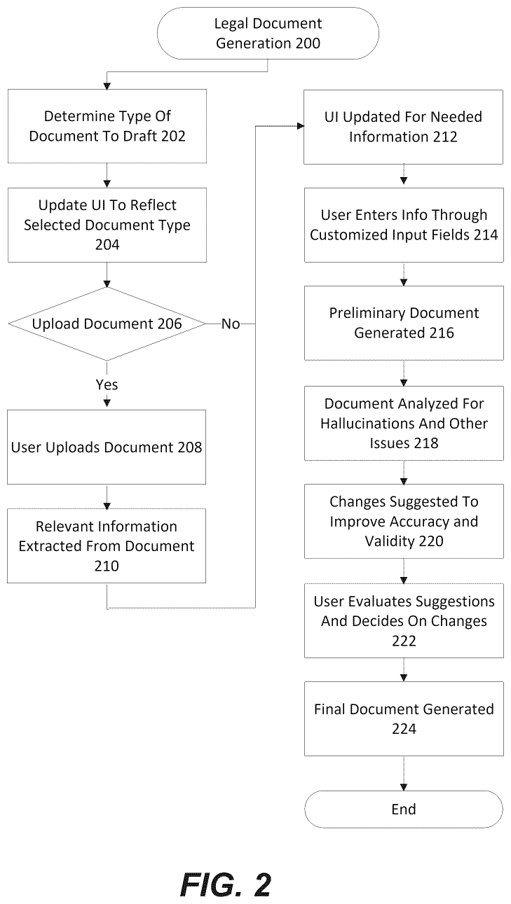

FIG. 2 illustrates one technique for automatic legal document generation at 200. According to various embodiments, legal document generation begins with determining the type of document to draft at 202, which establishes the framework for subsequent steps. Types of legal documents may include parcomplaints, briefs, motions, answers, discovery requests, agreements, and/or court orders. In particular embodiments, once the document type is identified, the user interface is updated to reflect the selected document type, customizing the input fields and format requirements at 204. At 206, it is determined if the user wants to upload a document. If the user selects yes, the user can proceed to upload an existing document at 208. After upload, relevant information is automatically extracted from the document using information extraction algorithms at 210. If the user selects no, the workflow follows an alternative path where the UI is updated to display fields for the specific information needed for the selected document type at 212.

According to various embodiments, the user then enters the required information through these customized input fields at 214. Using either the extracted information or manually entered data, a preliminary document is generated, likely utilizing language models at 216. This preliminary document undergoes analysis for hallucinations (fabricated cases or legal references) and other possible causes for dismissal, implementing verification checks at 218. Based on this analysis, changes are suggested to improve the document's accuracy and legal validity at 220. The user is presented with these suggestions and decides whether to accept the recommended changes at 222. Following the user's decision on modifications, the final document is generated at 224.

According to various embodiments, the system also facilitates generation of responsive legal documents including but not limited to answers to complaints, requests for production (RFPs), interrogatories (ROGs), and motions to dismiss. For responsive document generation, the system may import an original document being responded to, such as a complaint or discovery request and parses each allegation, request, or interrogatory into discrete items requiring individual responses. The language models analyze each item, referencing applicable legal standards, procedural rules, and factual information provided by the user to generate appropriate responses. For answers to complaints, the system suggests admissions, denials, or statements of insufficient information with supporting legal rationales. For discovery responses, the system formulates objections based on relevance, proportionality, privilege, and other grounds, while drafting substantive responses for non-objectionable requests. For motions to dismiss, the system identifies legal deficiencies in each cause of action, generates arguments based on applicable standards such as Rule 12 (b) (6), and incorporates relevant case law that has been verified through the hallucination prevention process. The system assembles these individual responses into a properly formatted document adhering to jurisdiction-specific requirements.

To further enhance accuracy, efficiency, and reduce hallucinations, the intelligent legal document generation system incorporates Retrieval-Augmented Generation (RAG) technology to pre-fetch relevant legal data before document drafting commences. The RAG component analyzes initial user inputs including jurisdiction selection, case type, and core factual allegations to identify potentially applicable legal authorities, doctrines, and precedents. This analysis triggers an automated retrieval process that queries specialized legal databases for pertinent case law, statutory provisions, regulatory frameworks, and procedural requirements specific to the selected jurisdiction and document type. A pre-fetching mechanism operates concurrently with user input collection, creating a comprehensive legal context buffer that is immediately available when document generation begins, thereby eliminating latency that would otherwise occur if legal research were conducted sequentially after all user inputs were collected.

The pre-fetched legal data significantly enhances subsequent document generation processes by providing the primary AI model with verified, relevant legal context before drafting begins. This contextual enrichment substantially reduces hallucination risk by grounding the AI model's generation process in actual legal authorities rather than requiring the model to rely solely on its internal parametric knowledge, which may contain outdated or incomplete legal information. When the system begins generating document sections at 216, the language model can reference this pre-fetched data to ensure accurate citation of controlling precedent, proper articulation of legal standards, and jurisdiction-compliant argumentation.

According to various embodiments, RAG can be optionally used to allow for legal research. According to various embodiments, the intelligent legal document generation system integrates robust legal research capabilities that operate both independently and in conjunction with document generation workflows. The legal research component implements targeted research across multiple authoritative sources including case law repositories, statutory compilations, regulatory databases, secondary sources, and jurisdiction-specific practice guides. In particular embodiments, the research system parses natural language queries from users, identifying legal concepts, factual scenarios, and jurisdictional constraints before transforming them into optimized search queries for LLM generation of particular portions of a legal research document.

In particular embodiments, legal research functionality operates as a separate component or is entirely integrated within the document generation workflow, allowing users to initiate research queries directly from partially drafted documents or from specific factual allegations during the information gathering process. When a user selects text within a draft document and initiates a research request, the system automatically extracts relevant context and generates appropriately scoped queries. In particular implementations, the system maintains persistent links between document sections and the research results that informed them, allowing for automatic updates if more recent or more relevant authorities are subsequently identified. The research component also implements the hallucination prevention mechanisms by using LLM verification or verified legal authorities against which Al-generated content can be validated. When the system encounters legal assertions or principles during the document drafting process that lack clear support in the pre-fetched authorities, it automatically initiates background research queries to verify these assertions, flagging potential inaccuracies before they are incorporated into the final document.

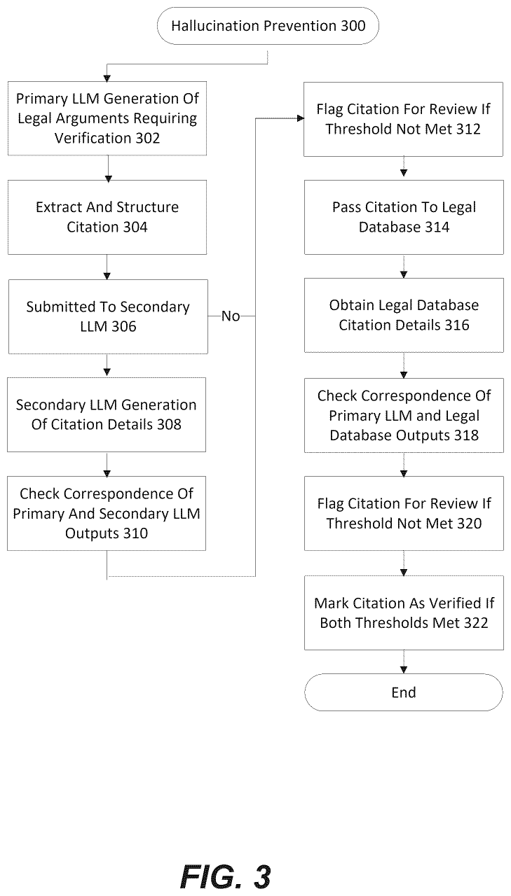

FIG. 3 illustrates one example of a technique for detecting and preventing AI hallucinations in legal document at 300. According to various embodiments, after the user inputs facts or uploads a complaint, the system runs a content extraction pipeline (using basic Named Entity Recognition or rule-based parsing) to identify parties, claims, etc. This structured data is fed into the LLM for generating a first draft. The system routes each draft segment back to the user with flagged items that might need confirmation (e.g., repeated discovery requests, possibly incorrect references). These flags are determined by comparing the LLM-generated text against the user's original factual data or previously extracted structured elements in the database.

According to various embodiments, a primary LLM generates legal arguments containing citations that require verification at 302. Each citation is extracted and structured into standardized format including case name, jurisdiction, and reference numbers at 304. These citations are then independently submitted to a secondary LLM without revealing the primary LLM's interpretation at 306. It should be noted that a secondary LLM does not necessarily need to be a different model, but may in fact be a separate instantiation of the same model. In some examples, this secondary LLM is a secondary session of the same LLM. The secondary LLM provides its own description and interpretation of each citation, with or without context specific details at 308. In particular embodiments, for case-specific verification, a hallucination prevention system compares how both LLMs interpret the facts of the case, identifies similarities in their understanding of key disputes, and analyzes consistency in how the citation is applied to those facts. For general citation verification (without specific facts), the system examines whether both LLMs identify the same legal doctrines established by the case, agree on the case's significance in legal history, and consistently describe the court's reasoning methodology and interpretive approach.

The system performs inter-LLM correspondence checking through multiple complementary techniques. In some embodiments, the hallucination prevention system computes semantic similarity using vector embeddings of both interpretations, extracts named entities and key facts from both texts to calculate overlap percentages, identifies claimed legal principles and holdings to verify consistency, and compares case outcomes and procedural histories for alignment. The hallucination prevention system applies different weights to these factors, prioritizing accuracy of holdings and legal principles at 310. The system checks if this composite correspondence score exceeds the first confidence threshold value (typically 80%); if a confidence threshold is not reached, the citation can be flagged for human or user review at 312.

According to various embodiments, the system can optionally pass the LLM's draft to a secondary “verification” microservice that either calls another LLM or a knowledge base API. In some embodiments, this service checks for obvious inconsistencies (like citing a case that's invalid). In some embodiments, citations passing the first threshold are then queried in authoritative legal databases at 314. The system retrieves official headnotes, summaries, and key holdings from these authoritative sources at 316. A second correspondence analysis is performed by comparing the primary LLM interpretations against the legal database outputs by using similar mechanisms including calculating semantic overlap with official headnotes, by verifying consistency with stated legal principles in the database, and checking accuracy of quoted text against the original opinion at 318. The system checks if this database correspondence score exceeds the second threshold value (typically 80%). If it does not, the citation is flagged for user review at 320. Citations passing both thresholds are marked as verified and reliable at 322. The verification results are logged to provide an audit trail of the verification process.

According to various embodiments, the system's back-end merges the verification service's results (e.g., confidence scores or flagged citations) with the user's segment data, then updates the user's next page to highlight potential hallucinations. In some embodiments, this might involve a color-coded front-end rendering or a pop-up prompting the user to edit, accept, or reject the flagged content.

Thus, the techniques and mechanisms of the present disclosure provide for a structured, component-based approach where each segment's data can be cross-referenced with known facts or external sources. This requires a back-end that can ingest partial results from two different sources (the main LLM+a verification engine) and unify them in real time for the front-end.

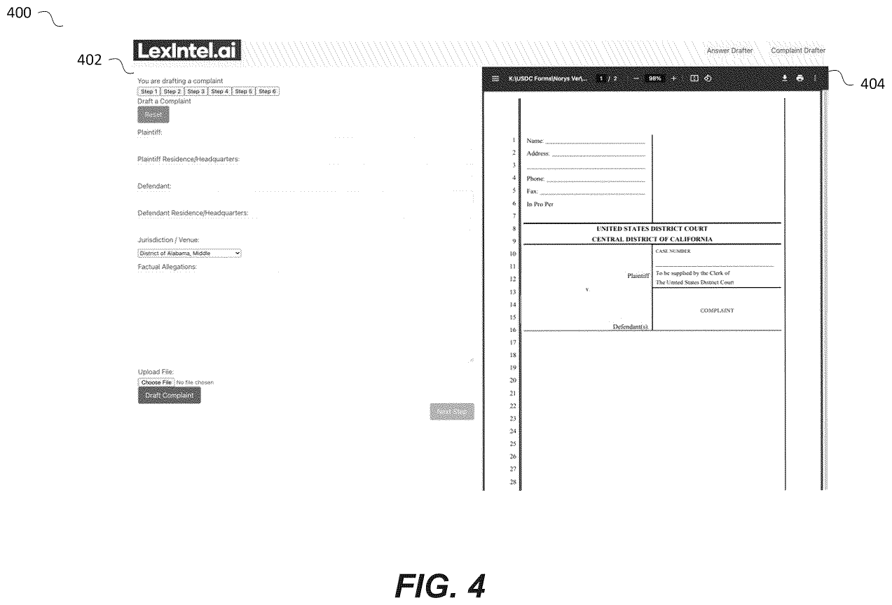

FIG. 4 illustrates a screenshot of an example user interface, in accordance with embodiments of the present disclosure. A user interface screenshot for legal document generation displays a dual-panel layout including a left panel and a right panel designed for attorneys and legal professionals at 400. The left panel features an indicator showing that the user is drafting a complaint followed by a structured six-step workflow. A variety of put fields are provided in left panel 402. The first input field is labeled “Plaintiff” with a text entry box for the Plaintiff name. Below this is a “Plaintiff Residence/Headquarters” field where the user enters the plaintiff's complete address information. The next section contains a “Defendant” field for entering the opposing party's name. This is followed by a “Defendant Residence/Headquarters” field for the defendant's location details.

According to various embodiments, a dropdown menu labeled “Jurisdiction/Venue” allows selection from common court options, with “United States District Court Central District of California” currently selected. A larger text entry area labeled “Factual Allegations” provides space for the attorney to detail the case circumstances, with an estimated word count displayed at the bottom corner. Adjacent to this text field is an “Upload File” button with an icon indicating document attachment capabilities. At the bottom of the left panel 402 is a prominent blue “Draft Complaint” button awaiting user activation at 418.

According to various embodiments, a right panel includes components of a generated legal document at 404. The right panel displays a professionally formatted example complaint with proper court heading, caption styling, numbered paragraphs, and appropriate spacing that matches the United States District Court Central District of California's required format. The example document includes properly formatted plaintiff and defendant information blocks, jurisdictional statements, factual allegations organized in numbered paragraphs, and concludes with a request for relief and signature block. According to various embodiments, a legal document formatting engine implements jurisdiction-specific formatting requirements to ensure compliance with local court rules and practices. The system maintains a comprehensive database of formatting specifications indexed by jurisdiction, court level, and document type, encompassing parameters such as margin dimensions, line spacing, font requirements, caption structures, signature block formats, exhibit designations, and page numbering conventions.

In particular embodiments, the formatting engine also implements specialized requirements for appellate courts, bankruptcy courts, and administrative tribunals, each with distinct pagination rules, record citation formats, and structural components. The system regularly updates its formatting database to reflect amendments to court rules, ensuring that generated documents consistently adhere to the most current requirements. When conflicts between general and specialized rules exist, the system applies hierarchical rule resolution, prioritizing the most specific applicable requirement. This comprehensive approach to jurisdiction-specific formatting significantly reduces the risk of document rejection based on technical non-compliance, thereby streamlining the filing process and avoiding procedural delays that could impact case progression and outcomes.

In particular embodiments, the end resulting document is presented in a window or sub-window on the right side of the screenshot at the same time. In some embodiments, the right window displays the progress of the final product in real time.

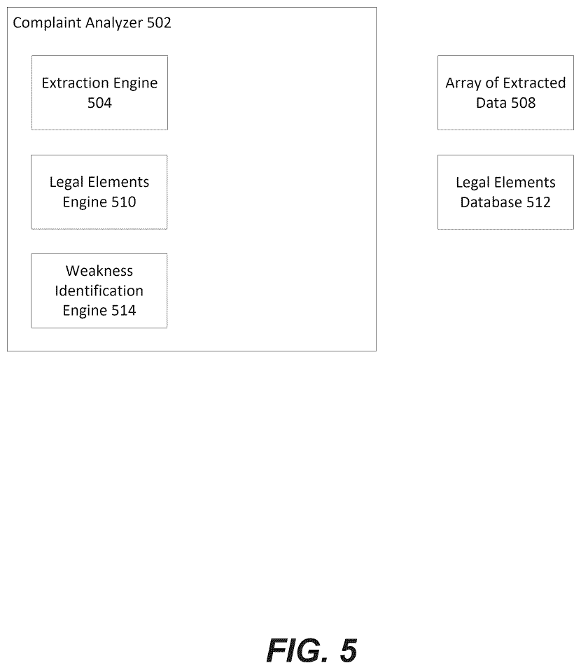

FIG. 5 illustrates one example of a complaint analyzer, in accordance with embodiments of the present disclosure. According to various embodiments, techniques and mechanisms provide a complaint analyzer 502 that automatically extracts facts and causes of action from legal complaints using an extraction engine 504. The extraction engine 504 may use natural language processing and machine learning to parse complaint documents, identifying key factual allegations, legal claims, and jurisdictional assertions. In particular embodiments, this extraction process transforms unstructured legal text into structured data elements that can be systematically analyzed and utilized for subsequent legal workflows. The analyzer 502 maintains an associative array 508 of extracted information including but not limited to: plaintiff identifiers, defendant details, venue information, chronological event sequences, and specific statutory or common law references that form the basis of each cause of action.

The complaint analyzer 502 further incorporates a legal elements engine 510 that breaks down each identified cause of action into its constituent legal requirements. For each cause of action extracted from the complaint, the system may reference a comprehensive database 512 of legal elements specific to the relevant jurisdiction, mapping the factual allegations to each required element. The legal elements engine 510 generates a visual representation that clearly delineates which factual allegations support each element of the claim, highlighting areas where factual support may be insufficient or ambiguous. This element-by-element analysis provides legal practitioners with insights into the structure of each cause of action, thereby allowing more efficient case assessment and response strategy development.

In particular embodiments, the complaint analyzer 502 implements a weakness identification component 514 that evaluates the complaint for potential deficiencies that could impact its legal viability. The system employs a two-pronged analytical approach: for plaintiffs, it identifies elements with insufficient factual support, statutory compliance issues, or jurisdictional vulnerabilities that could be addressed through amendments; for defendants, it flags potential grounds for dismissal, including failure to state a claim, statute of limitations issues, or jurisdictional defects. The weakness identification component 514 calculates confidence scores for each potential deficiency, ranking them by legal significance and likelihood of success.

According to various embodiments, the user interface depicted in FIG. 4 is not a conventional user interface. Instead, the techniques and mechanisms of the present disclosure provide for an improvement to the standard user interface by allowing on-the-fly output generation and real-time output display as the user types. Conventional user interfaces take multiple fields as input from the user and then process all the inputs together to generate an output once all the input fields are filled out by the user. However, errors in the output are not easily identified and a debugging process would need to be initiated in order to identify problematic inputs. It is worth noting that this problem is different from situations in which the inputs themselves are faulty and therefore cause error messages rather than generate a working output. The problem addressed by techniques and mechanisms of the present disclosure occurs when user inputs generate a working output that contains errors. As mentioned above, the source of such errors can be very difficult to identify. However, the techniques and mechanisms of the present disclosure provide for real-time processing and display of the generative output as the user types. According to various embodiments, each new input typed by the user generates a more complete output product that is additive to or a modification of the previous output state. In order to accomplish this, various embodiments include the following user interface architectural elements.

According to various embodiments, a React single-page module manages a user state. Managing a user state allows for segmented output display. Since each real-time output is generated based on sequential user inputs, the user can follow the output generation sequence and identify an erroneous output section and the input that led to the erroneous output. In some embodiments, the user interface allows the user to go back and change/modify the specific input that led to the erroneous output in real-time and without reloading of the page. In some embodiments, each drafting “segment” (e.g., Introduction, Factual Allegations, RFP sections) is rendered on its own page component.

According to various embodiments, when the user enters or updates information in segment A (e.g., parties/venue), the system front-end sends a POST request to a back-end microservice, which stores segment-specific data in a database. The system then retrieves that information to dynamically render the next page.

According to various embodiments, unlike a typical chat interface that simply appends text, the techniques and mechanisms of the present disclosure organize user inputs and LLM outputs into discrete data structures keyed by “section” or “cause-of-action.” Each discrete segment is retrieved and injected into the next “page” of the drafting workflow. This ensures the user sees a progressively compiled version of the entire document, rather than the unstructured chat messages found in conventional chat interfaces.

According to various embodiments, in addition to iterative in-page rendering, on each new page, the front-end merges prior segments' approved content into a single in-memory data model. When the user moves forward, the interface re-renders a consolidated “preview” of all approved sections so far. This approach requires the UI to maintain a partial but coherent view of the document state across multiple components--a more complex architecture than simple text output. Thus, the techniques and mechanisms of the present disclosure provide for a “segmented data flow” model that allows for incremental building of the output/document. Each segment's final text is version-controlled on a back-end server, thereby allowing the system to track user approvals/rejections, detect incomplete segments, and flag any mismatches. This continuous validation loop is a key difference from a standard chatbot or single-endpoint request.

According to various embodiments, one or more LLMs are used in the techniques and mechanisms of the present disclosure. While training LLMs is the standard method for achieving a desired output based on a particular prompt, training LLMs requires time and resources to pass a sufficient amount of training data into the LLMs. There is inevitably a latency associated with training the LLMs. In addition, since trained LLMs, are normally trained for a specific input/output combination, the bespoke LLM itself is required to get the desired output from the particular input. This means that a system utilizes the trained LLM, either has to include the LLM itself, which is very heavy weight, or has to be tied to that particular LLM, which reduces flexibility, high availability, and efficiency. However, training the LLMs is just one way of achieving the desired input/output combination. The techniques and mechanisms of the present disclosure also provide an alternative method for achieving such a goal. According to various embodiments, the techniques and mechanisms of the present disclosure provide a method for prompt engineering, as an alternative for training LLMs.

According to various embodiments, the system integrates an LLM API using specialized prompts. More specifically, the system converts user input field data into back-end calls to the LLM API with JSON payloads that include (a) user inputs, (b) relevant legal context (e.g., code sections, extracted complaint data), and (c) instructions on the desired segment structure. In some embodiments, because input field data is converted into back-end prompts and service calls, the system can remain LLM-agnostic. This may be describable as different LLMs are designed for different purposes. Thus, certain LLMs perform certain tasks better than others. The choice of LLM can be made based on the specific aspects in which the chosen LLM excels. In addition, another advantage of prompt engineering over LLM training is high availability. If one LLM system becomes unavailable for whatever reason, another different LLM can take its place, without a user noticing on the front end. This allows the system to have high availability, which is a large improvement over the standard method of training LLMs. In addition, because the LLMs themselves can be interchanged, both the front-end and back-end software clients can be light weight, as opposed to systems having trained bespoke LLMs. Having lightweight clients means more availability of resources and less processing cost and time.

In some embodiments, the system may have to perform a lightweight “fine-tuning” pass by feeding the model annotated examples of segment drafts. However, this occurs entirely on the back-end and occurs only when necessary. One example of needing to “fine-tune” is when the system switches from one LLM to another. It is important to note that this is not considered “training” because it is orders of magnitude faster and more efficient than traditional LLM training. According to various embodiments, most of the optimization is done via custom prompt templates and iterative prompting, where the system breaks down the overall drafting into smaller tasks using segmented prompt logic. One example of segmented prompt logic is reproduced below.

According to various embodiments, the user input field data is converted into one or more separate back-end (e.g., non-visible to the user) segment prompts, which are auto-generated from the system's back-end logic. In some embodiments, the back-end segment prompts require relevant user facts or parsed complaint data, which is fetched from a system database. In such embodiments, the system builds a prompt that references only that segment's relevant legal and factual context. Next, the payload is sent to the LLM endpoint for output generation. In some embodiments, the initial LLM response is stored in cache or on a back-end server. In some embodiments, this initial LLM response is still not visible to the user yet. In some embodiments, the initial LLM response is then compared with any “expected structure” or “legal template” in the system. After it passes a certain comparison threshold, then the system presents the LLM response to the user. In some embodiments, this entire process occurs on-the-fly and/or in real-time.

According to various embodiments, by subdividing the drafting process and carefully bundling context for each segment, the techniques and mechanisms of the present disclosure minimize extraneous or hallucinatory text. This is an intentional architectural design, which is a significant improvement over the standard “single prompt for the entire complaint” approach. The techniques and mechanisms of the present disclosure orchestrate multiple smaller queries, which are intermediary and invisible, with specialized instructions that effectuate a result similar to training LLMs themselves. The segmentation is one key to controlling a generic LLM's scope and ensuring the validity of the output by cross-checking each piece.

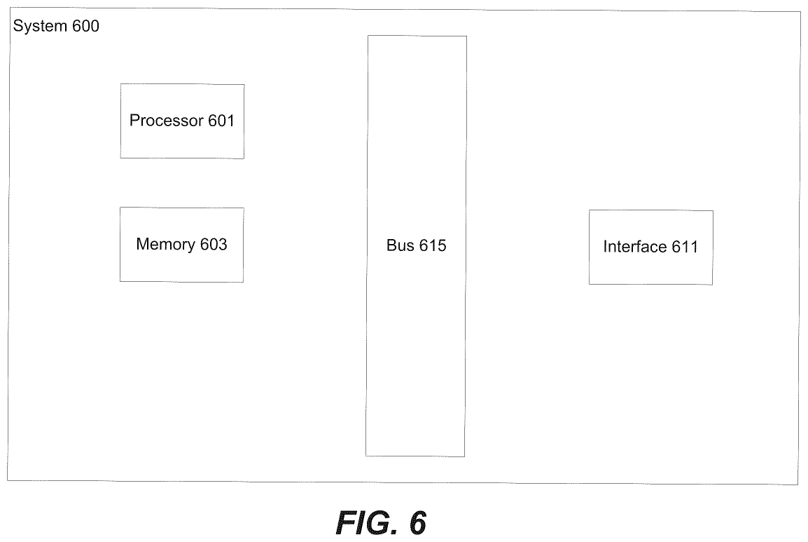

The examples described above present various features that utilize a computer system. However, embodiments of the present disclosure can include all of, or various combinations of, each of the features described above. FIG. 6 illustrates one example of a computer system, in accordance with embodiments of the present disclosure. According to particular embodiments, a system 600 suitable for implementing particular embodiments of the present disclosure includes a processor 601, a memory 603, an interface 611, and a bus 615 (e.g., a PCI bus or other interconnection fabric). When acting under the control of appropriate software or firmware, the processor 601 is responsible for implementing applications such as an operating system kernel, a containerized storage driver, and one or more applications. Various specially configured devices can also be used in place of a processor 601 or in addition to processor 601. The interface 611 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 600 is a computer system configured to generate documents, as shown herein. In some implementations, one or more of the computer components may be virtualized. For example, a physical server may be configured in a localized or cloud environment. The physical server may implement one or more virtual server environments. Although a particular computer system is described, it should be recognized that a variety of alternative configurations are possible. For example, the modules may be implemented on another device connected to the computer system.

In the foregoing specification, the present disclosure has been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure.

What is claimed is:

1. A method comprising:
receiving a request to generate a legal document;
receiving legal information associated with the request to generate the legal document;
generating a first query using the legal information to generate the legal document, the first query presented to a primary artificial intelligence (AI) model;
receiving a preliminary legal document result from the primary AI model;
checking for hallucinations by verifying a legal citation included in the preliminary legal document by using a secondary model, wherein the legal citation references a court case;
generating a verified legal document including the legal citation.

2. The method of claim 1, wherein the legal citation is generated with a confidence score, wherein the confidence score corresponds with a likelihood the legal citation is not a hallucination.

3. The method of claim 1, wherein the legal citation is one selected from the group consisting of: case law, a statute, a regulation, and an administrative code.

4. The method of claim 1, wherein the primary AI model is a large language model (LLM).

5. The method of claim 1, wherein the secondary model is a second instantiation of the same primary AI model.

6. The method of claim 1, wherein the secondary model is a legal database specializing in access to case law, state and federal statutes, administrative codes, and law review articles.

7. The method of claim 1, wherein the verified legal document is selected from the group consisting of: a pleading, a discovery document, a pre-trail filing, a dispositive filing, a court filing, a procedural document, and an appellate filing.

8. The method of claim 1, wherein legal information associated with the request comprises jurisdiction information, plaintiff name, defendant name, and facts of a case.

9. The method of claim 1, wherein if verifying the legal citation using the secondary model does not reach a confidence threshold, the citation is flagged for human review.

10. The method of claim 1, wherein a user interface accepts user input in a left panel and outputs the legal document in a right panel.

11. The method of claim 1, wherein Retrieval Augmented Generation (RAG) is used to prefetch data associated with legal citations corresponding to authoritative sources.

12. The method of claim 1, wherein a complaint analyzer extracts facts and causes of action from a complaint, breaks down the legal elements for each cause of action, and identifies weaknesses in the complaint.

13. A system comprising:
an interface configured to receive a request to generate a legal document along with legal information associated with the request to generate the legal document;
a prompt generator configured to generate a first query using the legal information to generate the legal document, the first query presented to a primary artificial intelligence (AI) model;
a primary AI model interface configured to receive a preliminary legal document result from the primary AI model;
a hallucination prevention component configured to check for hallucinations by verifying a legal citation included in the preliminary legal document by using a secondary model, wherein the legal citation references a court case, wherein a verified legal document including the legal citation is generated after verifying the legal citation.

14. The system of claim 13, wherein the legal citation is generated with a confidence score, wherein the confidence score corresponds with a likelihood the legal citation is not a hallucination.

15. The system of claim 13, wherein the primary AI model is a large language model (LLM).

16. The system of claim 13, wherein the secondary model is a secondary AI model.

17. The system of claim 13, wherein the secondary model is a legal database specializing in access to case law, state and federal statutes, administrative codes, and law review articles.

18. The system of claim 13, wherein the verified legal document is a legal pleading document.

19. The system of claim 13, wherein legal information associated with the request comprises jurisdiction information, plaintiff name, defendant name, and facts of a case.

20. A non-transitory computer readable medium comprising:
computer code for receiving a request to generate a legal document;
computer code for receiving legal information associated with the request to generate the legal document;
computer code for generating a first query using the legal information to generate the legal document, the first query presented to a primary artificial intelligence (AI) model;
computer code for receiving a preliminary legal document result from the primary AI model;
computer code for checking for hallucinations by verifying a legal citation included in the preliminary legal document by using a secondary model, wherein the legal citation references a court case;
computer code for generating a verified legal document including the legal citation.
